(19) United States
(12) Patent Application Publication
(10) Pub. No.: US 2007/0221074 A1
(43) Pub. Date: Sep. 27, 2007

(54) Spray dampening system in printing presses

(75) Inventors: Olli Saarniaho, Vaasa (FI); Heikki Lindqvist, Vaasa (FI)

Correspondence Address: NIXON & VANDERHYE, PC, 901 NORTH GLEBE ROAD, 11TH FLOOR, ARLINGTON, VA, 22203, US

(73) Assignee: VESLATEC OY, Vaasa (FI)

(21) Appl. No.: 11/723,756

(22) Filed: Mar. 21, 2007

(30) Foreign Application Priority Data
Mar. 21, 2006 (FI) 20060265

(51) Int. Cl. B41L 25/00

(52) U.S. Cl. 101/148

(57) ABSTRACT

The invention relates to a spray dampening system in printing presses, comprising: a rotating roller (2); nozzles (3) facing the roller; a pressurized piping (11) for supplying water or other fluid to the nozzles; control valves (7), along with electrical actuators therefor, in association with each nozzle, said control valves including a closing and opening spindle (1). Said electrical actuators comprise: an adjustment rod (5) of some MSM material, having its first end in contact with the spindle (1) and its second end resting against a stationary base (10), a return element (12), as well as a coil assembly surrounding the adjustment rod for establishing a magnetic field (14) applied to the adjustment rod. The field intensity enables changing the adjustment rod length and setting a spindle position in the control valve for thus regulating the amount of water or fluid flowing through the nozzles (3) as a spray (8).

### FIELD OF THE INVENTION

The invention relates to a spray dampening or spray moisturizing system in printing presses, which comprise at least one rotating roller, a number of nozzles pointing towards said roller for producing water or fluid sprays, a pressurized piping adapted to supply water or other fluid to said nozzles, and control valves being adapted to regulate the amount of water or fluid flowing to and through said nozzles.

### BACKGROUND OF THE INVENTION

In printing presses, the dampening system consists of a pressurized piping and a valve system associated therewith. E.g. the patent publication U.S. Pat. No. 4,708,058 discloses an offset lithographic press, which is provided with a rotatable cylinder, a lithographic plate mounted on said cylinder and having at least one ink receptive area, and means for providing ink to said at least one ink respective area of said plate, a dampening system for delivering ink-repellant dampening fluid to said plate comprising: a first roller in rolling engagement with said plate and having a flexible surface with a Shore A durometer hardness of 25 to 40; a second roller in rolling contact with said first roller and having an outer surface selected from the group consisting of chromium, nickel and ebonite; a third roller in rolling engagement with said second roller and having a flexible surface with a Shore A durometer hardness of 25 to 40; said first roller and said second roller presenting a first nip therebetween and said second roller and said third roller presenting a second nip therebetween, said first roller, said second roller and said third roller being spaced from said means for providing ink to said plate for generally precluding the entry of substantial quantities of ink into said dampening system, each of said surfaces of said first, second and third rollers causing respective rollers to be driven at essentially the same speed of rollers in contact with each of said surfaces; a supply of dampening fluid pressurized to approximately 30 psi to approximately 60 psi; conduit means coupled with said fluid supply; a plurality of nozzles coupled with said conduit means for spraying dampening fluid toward said third roller; valve means associated with said conduit means and operable to interrupt the flow of dampening fluid through said conduit means; and control means connected to said valve means for selective operation of the latter, said control means being operable to enable flow of said fluid from said conduit through said nozzles during a pulse of time having a duration ranging from approximately 5 milliseconds to approximately 75 milliseconds, said control means being operable to provide a series of said pulses having a frequency ranging from approximately 50 pulses per minute to approximately 600 pulses per minute at full press speed, said nozzles being spaced apart from each other a distance in the range of approximately 4 inches to 10 inches, said nozzles being spaced from said third roller a distance in the range of approximately 2 inches to approximately 4 inches, said spacing of said nozzles relative to each other and said spacing of said nozzles relative to said third roller being such that the pattern of spray on said third roller provided by each nozzle overlaps the pattern of spray on said third roller provided by adjacent nozzles for substantially uniform distribution of said dampening fluid to said third roller along essentially the entire length of said third roller and to provide even transfer of said dampening fluid from said third roller to said second and first rollers and thereby to said plate as said dampening fluid is metered through said first nip between said first and second roller and through said second nip between said second and third roller.

The purpose of dampening or moisturizing systems in printing presses is to dispense a correct amount of water or dampening fluid onto a roller in an offset printing press. What is important about the systems is that the amount of water or the amount of dampening fluid be exactly correct, the droplet size of water/fluid be correct, the water/fluid be evenly distributed on the roller surface, and that the adjusted values remain constant or at set values. The required amount of water or the required amount of fluid is subject to variation according to the amount of ink used in printing, the grade of printing paper and the speed of a printing press. If necessary, the required amount of water/fluid may also fluctuate during a printing process. In traditional systems—such as the one shown in FIG. 7—the supply of water is thus effected by means of a pressurized piping 11 connected to nozzles, and the spraying onto a roller or rollers 2 is effected by nozzles 3 disposed side by side along the length of the roller, such that the obtained total spraying range or total spraying area covers the roller 2 over its entire length. A range or an area 4 covered by the spray 8 of one nozzle is generally between 100 mm and 200 mm in breadth in the longitudinal direction of the roller, which respect the width W of a printing press. Thus, the number of nozzles 3 depends on the width W of a printing press. The nozzles are mounted on a stationary spray bar 15 at equal interspaces. The width of a water spray, the size of a droplet, and the shape of a spray are determined by the size and design of a nozzle 3. The desired amount of water is rationed by opening and closing each control valve in association with each nozzle 3 individually at a given frequency. Typically, the valve frequency is 100 . . . 200 Hz. Traditionally, the valve spindle is controlled by valve-specific solenoids 30. In this case, the spindle has two positions—totally shut and totally open. Therefore, the regulation is only effected by changing the open/shut frequency of the solenoids.

### SUMMARY OF THE INVENTION

According to the invention improvements in printing presses and in their use should be and is achieved.

The invention concerns a spray dampening system in printing presses, which comprise: at least one rotating roller; a number of nozzles pointing towards said roller and producing water or fluid sprays; a pressurized piping adapted to supply water or other fluid to said nozzles; control valves each having a valve body, a water or fluid opening in said valve body, and an electrical actuator therefor and each being in flow communication with a respective one of said nozzles, said control valves being adapted to regulate the amount of water or fluid flowing to and through said nozzles. According to the invention each of said control valves is provided with a spindle movable towards closing and opening relative to said valve body; and that said electrical actuators are magnetic-shape-memory actuators, comprising: a stationary base, an adjustment rod or ring of a magnetic-shape-memory material, having a length with a first end thereof in contact with the spindle and a second end thereof resting against the stationary base, a counter spring or an electrical counter force device, a coil assembly surrounding the adjustment rod or ring for establishing a magnetic field having a variable intensity to said adjustment rod/ring, and which variable intensity enables changing the length of said adjustment rod/ring as actuator modes and thereby adjusting said spindle in the control valve towards said closing or towards said opening or maintaining a prevailing position, whereupon the amount of water or fluid flowing through the nozzle(s) is regulated. More precise and faster control is attained by using electrical voltage/current as the control parameter, whereupon different parameter values cause change ΔL of some dimension of the MSM material piece and hence a change in the valve gap between the spindle and the valve body regulating the water/fluid flow through the valve gap.

### BRIEF DESCRIPTION OF THE DRAWINGS

FIG. 1 shows schematically the first embodiment of the valve solution according to the invention for regulating the amount of water/fluid supplied to each nozzle in a spray dampening system, viewed in direction I of FIG. 7. In this embodiment the magnetic-shape-memory actuator has a variable linear length and moves the spindle towards the water/fluid opening of the valve body to close or decrease the water/fluid flow through the nozzle when activated.

FIG. 2 shows schematically the second embodiment of the valve solution according to the invention for regulating the amount of water/fluid supplied to each nozzle in a spray dampening system, viewed in the same direction as in FIG. 1. In this embodiment the magnetic-shape-memory actuator has a variable linear length but moves the spindle away from the water/fluid opening of the valve body to open or increase the water/fluid flow through the nozzle when activated.

FIG. 3 shows schematically the third embodiment of the valve solution according to the invention for regulating the amount of water/fluid supplied to each nozzle in a spray dampening system, viewed in the same direction as in FIGS. 1 and 2. In this embodiment the magnetic-shape-memory actuator has a variable curvature attained by changing linear length and moves the spindle towards or away from the water/fluid opening of the valve body to close/open or decrease/increase the water/fluid flow through the nozzle when activated.

FIG. 4A shows schematically the fourth embodiment of the valve solution according to the invention for regulating the amount of water/fluid supplied to each nozzle in a spray dampening system, viewed in the same direction as in FIGS. 1 to 3. In this embodiment the magnetic-shape-memory actuator has a variable rotation angle attained by changing circular length and moves the spindle towards or away from the water/fluid opening of the valve body to close/open or decrease/increase the water/fluid flow through the nozzle when activated.

FIG. 4B shows schematically one possible configuration of the magnetic-shape-memory actuator of the fourth embodiment of the invention for attaining rotary motion of the spindle, viewed in the direction II of FIG. 4.

FIG. 5 shows schematically the fifth embodiment of the valve solution according to the invention for regulating the amount of water/fluid supplied to each nozzle in a spray dampening system, viewed in the same direction as in FIGS. 1 to 4. In this embodiment the magnetic-shape-memory actuator has a variable length and moves the spindle away from the water/fluid opening of the valve body to open or increase the water/fluid flow through the nozzle when activated, like the second embodiment, but further comprise a magnetic brake, whereupon the spindle can be adjusted to have intermediate positions between total closing and total opening the nozzle.

FIG. 6 shows schematically the sixth embodiment of the valve solution according to the invention for regulating the amount of water/fluid supplied to each nozzle in a spray dampening system, viewed in the same direction as in FIGS. 1 to 5, but visualizing a portion of the components thereof only. The principle shown is a stepwise or stepless adjustment of the spindle, which is attainable either with the magnetic brake of FIG. 5 or using a position sensor with an electronic control circuit.

FIG. 7 shows a prior known arrangement schematically, i.e. state of the art in an axonometric view. Here the adjustment of the water/fluid amount is performed by changing the frequency of the solenoids.

### DESCRIPTION OF THE PREFERRED EMBODIMENTS

Concerning spray dampening or spray moisturizing systems, the printing presses—typically offset printing presses—comprise for this purpose at least one rotating roller 2, and a number of nozzles 3 pointing towards this at least one roller 2 and producing water or fluid sprays 8. The nozzles 3 are fixed side by side in a rigid and stationary spray bar 15, and a pressurized piping 11 is arranged between the nozzles and a reservoir, not shown in the figures, for supplying water or other fluid to said nozzles. There are control valves 7, i.e. one control valve for each nozzle, each of the control valves 7 having a valve body 13, a water or fluid opening 17 in said valve body for producing the fluid spray 8, and an electrical actuator 16. Each control valve is in flow communication with a respective one of the nozzles, said control valves being adapted to regulate the amount of water or fluid flowing to and through said nozzles 3. It shall be noted that in these nozzle 3 control valve 7 combinations nozzles and valves can be separate units or built as one unit.

According to the invention each of said control valves 7 is provided with a spindle 1 movable towards closing and opening relative to said valve body 1, and the electrical actuators 16 are magnetic-shape-memory (=MSM) actuators 20. The actuator comprise a stationary base 10, which is e.g. supported directly or indirectly by the spray bar 15, an adjustment rod 5a or ring 5b of a magnetic-shape-memory material, having a length L with a first end 15a thereof in contact with the spindle 1 and a second end 15b thereof resting against the stationary base 10, and a counter spring 12, 14 or a magnetic-shape-memory (=MSM) counter force device 24. The actuator further comprises a coil assembly 19 surrounding the adjustment rod 5a or ring 5b for establishing a magnetic field MF having a variable intensity to the adjustment rod/ring 5a/5b. This variable intensity of the magnetic field MF enables changing the length L of said adjustment rod/ring. This way the position of the spindle 1 in the control valve 7 is changed either towards closing or towards opening or maintaining a prevailing position, whereupon the amount of water or fluid flowing through the nozzles 3 is regulated.

Accordingly, in a valve solution according to the invention the valve 7 has its spindle 1 controlled by means of an MSM actuator 20, replacing a traditional solenoid or other electrical actuator. Herein, the MSM actuator refers to a device making use of a Magnetic-Shape-Memory material in the actuator. The return motion is affected by means of a counter spring 12 or by another MSM actuator or counter force device 24. The adjustment rod 5a or the adjustment ring 5b can produce the movement of the spindle 1 to closing direction or a closing force S1 for the spindle, and the counter spring 12 or counter force device 24 the opposite movement to opening direction or an opening force S2 for the spindle. Alternatively, the adjustment rod 5a or ring 5b can produce the movement of the spindle 1 to opening direction, or an opening force S2 for the spindle, and the counter spring 12 or counter force device 24 the opposite movement to closing direction, or a closing force S1 for the spindle. In both cases there is a change of the length L of said adjustment rod/ring, and this change of length can be called as actuator modes ΔL. Hence, the motion in a magnetic-shape-memory actuator occurs by transmission from a block of some magnetic-shape-memory material, the size of said block being augmentable by means of a magnetic field 14 by as much as 10% from the original size. Thus, if a motion of 1 mm is required, the chosen length of an MSM adjustment rod 5 will be 10 mm. Such materials have been described e.g. in publication Tellinen, Suorsa, Jääskeläinen, Aaltio, Ullakko: “Basic Properties of Magnetic Shape Memory Actuators”—8th International Conference ACTUATOR 2002, Bremen, Germany, Jun. 10-12, 2002.

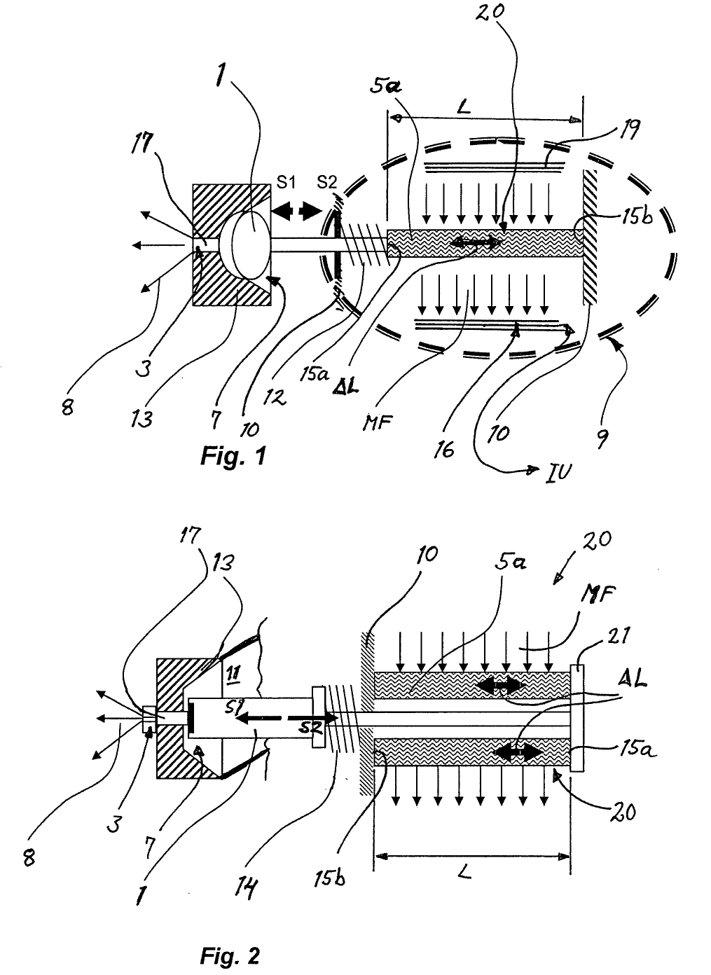

In a first embodiment of the invention—as shown in FIG. 1—for the control valve 7, the adjustment rod 5a of an MSM material has its first end pushing the spindle rod in contact therewith over a required distance towards a body 13 of the valve 7 respective a closing force S1, with the magnetic field 14 switched on or in a more powerful state. The magnetic-shape-memory adjustment rod has its second end resting against a rigid, stationary base 10 of the device. Consequently, the spindle 1 is pressed towards or into contact with the valve's 7 body, thus blocking the discharge of water/fluid from the nozzle's 3 orifice or, alternatively, reducing the flow of water/fluid as a spray 8 from the nozzle's 3 orifice as a result of downsizing the gap between the spindle 1 and the valve body. Upon movement, e.g. in response to the spring 12, in an opposite direction with the magnetic field 14 switched off or in a less powerful state respective an opening force S2, the gap between the spindle 1 and the valve body becomes larger, increasing the flow of water/fluid from the nozzle's 3 orifice as the spray 8.

In a second embodiment of the invention—as shown in FIG. 2—for the control valve 7, the adjustment rod 5a of an magnetic-shape-memory material retracts the spindle 1 across a required distance ΔL with the opening force S2, enhancing the flow of water/fluid as the spray 8, while the counter spring 14 or another such MSM counter device 24 urges the spindle with the closing force S1, reducing the flow of water/fluid through the valve 7. In this case the rigid, stationary base 10 can be between the counter ring 14 and the adjustment rod 5a, and the spindle 1 extends e.g. through a hole of the adjustment rod making contact via a flange 21 with second end 15b of the rod.

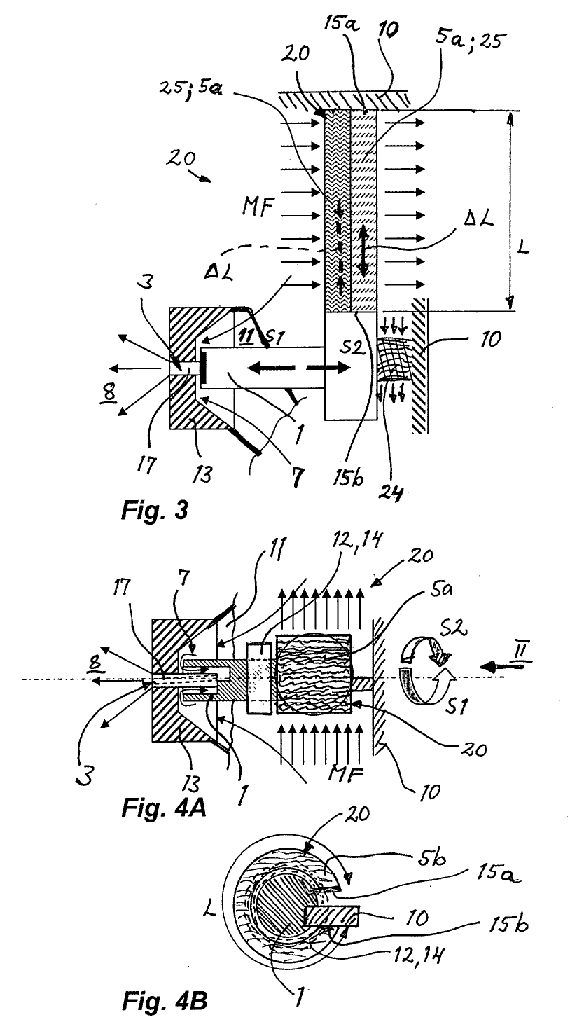

In a third embodiment of the invention—as shown in FIG. 3—for the control valve 7, the adjustment rod 5a of an magnetic-shape-memory material is connected with a additional piece 25 of non-SMS material. When a magnetic field MF having a variable intensity is now allowed to affect the combination of adjustment rod 5a and the additional piece 25, this combination is urged to bend or curve in respect to the rigid, stationary base 10, whereupon the second end 15b moves the attached spindle towards closing or towards opening. Further, here it is used electrical counter force device 24, which comprise a magnetic-shape-memory piece, to which a magnetic field mf can be directed to cause an opposite movement or force than the adjustment rod 5a of a magnetic-shape-memory material. The alternation between working of the adjustment rod and the electrical counter force device may be attained by activating the other magnetic field mf while the main magnetic field MF is non-activated, and activating the main magnetic field MF while the other magnetic field mf is non-activated.

A fourth embodiment of the invention—as shown in FIGS. 4A and 4B—for the control valve 7 is analogous to the system of the first embodiment, or alternatively analogous to the system of the second embodiment, the MSM-element being now in curved for, i.e. it is an adjustment ring 5b having a form of a letter C. Otherwise the configuration of the adjustment ring 5b can be circular, toroidal or tubular, but there is a radial slit or opening, whereupon the second end 15b can be supported by the rigid, stationary base 10 extending into the opening, and the first end 15a can rotate the spindle 1 being in contact with this first end. When a magnetic field MF having a variable intensity is now allowed to affect the adjustment ring 5b, its circular or peripheral length L changes and makes rotational movement or closing force S1. Depending on the detailed structure the rotational movement may cause alternatively an opening force S2, too. In this alternative the counter spring 12, 14 can be spiral spring or the like.

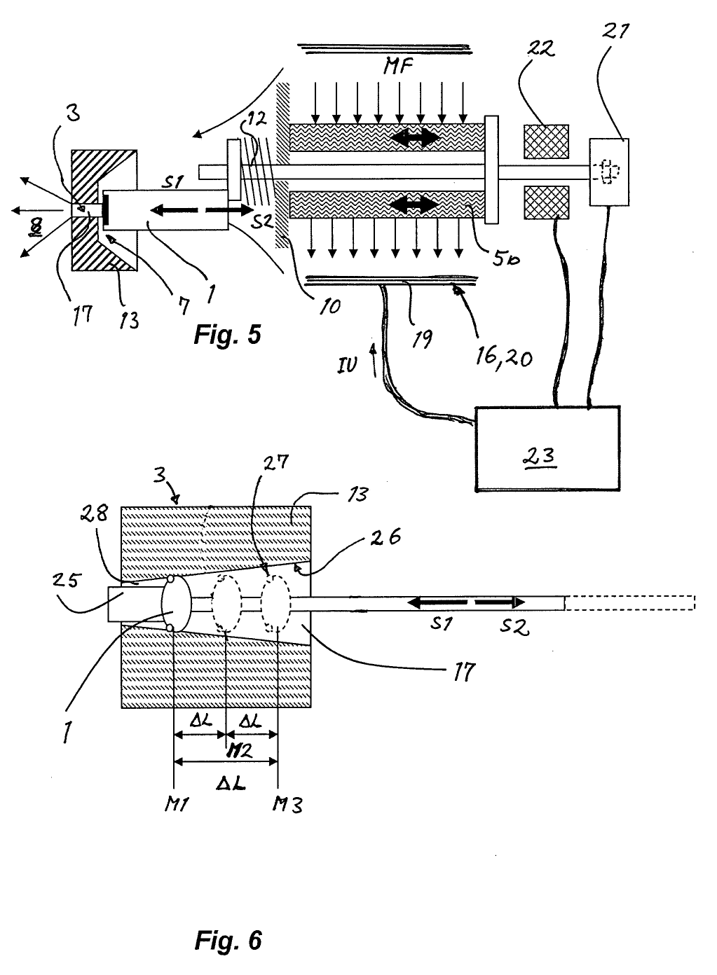

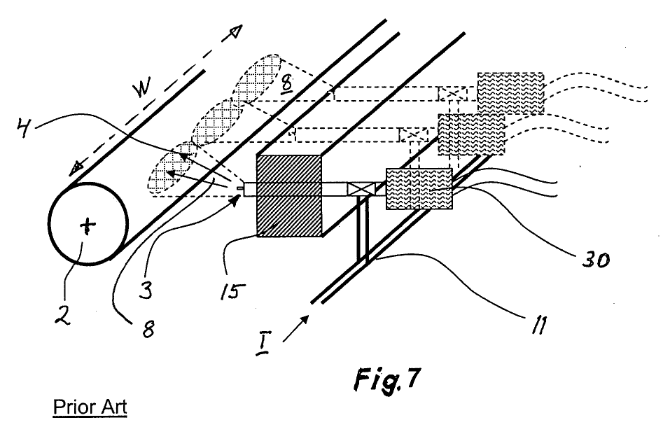

In a fifth embodiment of the invention—as shown in FIG. 5—for the control valve 7, the adjustment rod 5a or the adjustment ring 5b as well as the spindle construction can be any of the above described. Here the spray dampening system comprises a spindle position sensor 21 and a magnetic spindle brake 22, which can stop or slow down the movement of the spindle 1. Here is also shown the control unit 23, which controls at least the electrical current/voltage IU fed to the coil assembly 19 of the magnetic-shape-memory actuator 20. The spindle position sensor 21 and/or the magnetic spindle brake 22 are/is also—if present in the system—connected to the control unit, whereupon the prevailing position of the spindle can be directly detected, and the electrical current/voltage IU that shall be fed to the coil assembly 19 can be calculated utilizing a proper algorithm.

FIG. 6 shows the operation of the nozzle 3 in combination with the spindle 1 when operated with the adjustment rod 5a or adjustment ring 5b of a magnetic-shape-memory material according to the invention. When the spindle 1 in the control valve 7 is operated as described earlier in this text towards the closing, which is marked by the actuator mode M1, the spindle 1 is pressed by closing force S1 against the inner wall 26 of the fluid opening 17 of the valve body 13, whereupon the water/fluid spray 8 is deactivated. In the opposite case when the spindle 1 in the control valve 7 is operated as described earlier in this text towards the opening, which is marked by the actuator mode M3, the spindle 1 is released or ejected by opening force S2 from contact with the inner wall 26 of the fluid opening 17, whereupon the water/fluid spray 8 is activated or maximized through larger gap between the spindle and the valve body. In an intermediate mode, which is marked by the actuator mode M2, the spindle 1 is either moved by closing force S1 or opening force S2 or not moved because of balance between the closing and opening forces from contact with the inner wall 26 but not totally released or ejected, i.e. maintained in an intermediate position, whereupon some water/fluid spray 8 is present through the gap between the spindle 1 and the valve body 13. The maximum change ΔL in this case is difference between the closed position=actuator mode M1 and the totally open position=actuator mode M3. There can be additional parts 25 for controlling the spray configuration and/or division of droplets in the spray etc. at the outlet orifice 28 of the nozzle 3. As can be seen the change ΔL of the length L of the adjustment rod 5a or adjustment ring 5b can smaller or larger. Of course the spindle have unlimited amount of actuator modes. The inner wall 26 of the fluid opening 17 and the outer surface 27 of that end of the spindle acting in the opening 17 has configurations or forms that provide a proper change in the water/fluid flow as the response to the change ΔL of the length L of the adjustment rod/ring 5a, 5b.

In general, the length L of the adjustment rod 5a can be either a linear length or the length L of the adjustment ring 5b can be a circular length. The counter spring can be an opening spring 12 acting against a closing force S1 of said spindle 1, or a closing spring 14 acting against an opening force S2 of said spindle 1. These forces of course originate from the adjustment rod 5a or ring 5b of a magnetic-shape-memory material. Further, the adjustment rod 5a or the adjustment ring 5b respectively is configured to produce an elongation or a bending or a rotation or a combination movement upon effect of said magnetic field MF. The variable intensity of said magnetic field MF is affected by changing electrical current and/or electrical voltage IU in the coil assembly 19 of said electrical actuator 16. Normally the electrical current/voltage IU is direct current/voltage. Accordingly, the operating forms of the magnetic-shape-memory actuator 20 can be elongation, i.e. change of length, or bending, or rotation, or a combination of these. The system according to the invention can further comprise magnetic or electrical or mechanical etc. breaking or locking mechanism for stopping the spindle movement or maintaining the spindle in a certain position, or in any of the multiple actuator modes. The system according to the invention can also comprise one or several sensors for detection of its positions or movements. The MSM actuator is protected from water and fluids by means of an airtight cover 9 of plastics or metal.

Benefits provided by an MSM actuator over prior known solutions are as follows:

1. Mechanical structure simple

2. Structure sturdy and durable

3. No moving parts except for motion return spring and spindle

4. Nozzle and MSM actuator make up an integrated assembly

5. Frequency adjustable over a broad range of 0 . . . 1 kHz

6. Adjustment can be implemented in various ways:
a. by changing frequency
b. by adjusting pulse duration
c. by having the valve operate proportionally, in other words the spindle can have a position other than shut or open
d. a combination of some of the principles a to c.

7. The above modes of adjustment enable a precise dosage for the amount of water

8. Spray valve bar is more compact in size (saving space)

9. Modular structure is feasible

10. Adjustments remain constant.

Applications include printing roller dampening, counter-roller cleaning, paper web dampening, dampening-inking, dampening-coating and washing of rollers.

1. A spray dampening system in printing presses, which comprise:
at least one rotating roller;
a number of nozzles pointing towards said roller and producing water or fluid sprays;
a pressurized piping adapted to supply water or other fluid to said nozzles;
control valves each having a valve body, a water or fluid opening in said valve body, and an electrical actuator therefor and each being in flow communication with a respective one of said nozzles, said control valves being adapted to regulate the amount of water or fluid flowing to and through said nozzles;
wherein each of said control valves is provided with a spindle movable towards closing and opening relative to said valve body; and that said electrical actuators are magnetic-shape-memory actuators, comprising:
a stationary base,
an adjustment rod or ring of a magnetic-shape-memory material, having a length with a first end thereof in contact with the spindle and a second end thereof resting against the stationary base,
a counter spring or an electrical counter force device,
a coil assembly surrounding the adjustment rod or ring for establishing a magnetic field having a variable intensity to said adjustment rod/ring, and which variable intensity enables changing the length of said adjustment rod/ring and thereby adjusting said spindle in the control valve towards said closing or towards said opening or maintaining a prevailing position, whereupon the amount of water or fluid flowing through the nozzle(s) is regulated.

2. A spray dampening system according to claim 1, wherein the length of the adjustment rod is a linear length.

3. A spray dampening system according to claim 1, wherein the length of the adjustment ring is a circular length.

4. A spray dampening system according to claim 1, wherein the counter spring is:
a opening spring acting against a closing force in said spindle, or
a closing spring acting against an opening force in said spindle.

5. A spray dampening system according to claim 1, wherein said adjustment rod or said adjustment ring respectively configured to produce an elongation or a bending or a rotation or a combination movement upon effect of said magnetic field.

6. A spray dampening system according to claim 1, wherein the variable intensity of said magnetic field is affected by changing electrical current and/or electrical voltage in the coil assembly of said magnetic-shape-memory actuators; and that electrical current/voltage is direct current/voltage.

7. A spray dampening system according to claim 1, wherein said electrical counter force device is a magnetic-shape-memory counter force device.

8. A spray dampening system according to claim 1, wherein it further comprises a control unit for controlling at least electrical current and/or electrical voltage in the coil assembly of said magnetic-shape-memory actuators.

9. A spray dampening system according to claim 1, wherein it further comprises a spindle position sensor and/or a magnetic spindle brake connected to the control unit.

10. A spray dampening system according to claim 5, wherein the variable intensity of said magnetic field is affected by changing electrical current and/or electrical voltage in the coil assembly of said magnetic-shape-memory actuators; and that electrical current/voltage is direct current/voltage.

11. A spray dampening system according to claim 8, wherein it further comprises a spindle position sensor and/or a magnetic spindle brake connected to the control unit.
